(19) United States
(12) Patent Application Publication
(10) Pub. No.: US 2003/0216497 A1
(43) Pub. Date: Nov. 20, 2003

(54) Scratching-resistant resin plate and process for producing the same

(75) Inventors: Yoshimi Nakagawa, Kyoto-shi (JP); Tomohiro Mizumoto, Niihama-shi (JP)

Correspondence Address: SUGHRUE MION, PLLC, 2100 PENNSYLVANIA AVENUE, N.W., WASHINGTON, DC, 20037, US

(73) Assignee: SUMITOMO CHEMICAL COMPANY, LIMITED

(21) Appl. No.: 10/367,783

(22) Filed: Feb. 19, 2003

(30) Foreign Application Priority Data
Feb. 22, 2002 (JP) 2002-046055
Apr. 10, 2002 (JP) 2002-107650

(51) Int. Cl. C08K 5/09; C08K 5/12; B32B 27/00

(52) U.S. Cl. 524/285; 428/500; 524/300; 524/306

(57) ABSTRACT

A scratching-resistant resin plate is provided, the plate comprising a cured coating and a methyl methacrylate-styrene copolymer substrate. The cured coating comprises resin composition (i) which contains a compound having an alicyclic ring and one or two (meth) acryloyloxy group(s) in its molecule, and a compound having at least three (meth)acryloyloxy groups in its molecule; and/or resin composition (ii) which contains a compound having an aromatic ring and a (meth)acryloyloxy group in a ratio of (meth)acryloyloxy group to aromatic ring of at least three. The scratching-resistant resin plate has a sufficient adhesion of the cured coating with to the methyl methacrylate-styrene copolymer substrate and has a sufficient surface hardness.

### FIELD OF THE INVENTION

The invention relates to a low-hygroscopicity and scratching-resistant resin plate comprising a substrate made from a methyl methacrylate-styrene copolymer-based resin and a cured coating formed on the substrate, and relates to a process for producing the resin plate.

### BACKGROUND OF THE INVENTION

Conventionally, for example, a transparent resin plate has been used widely for a front panel for a display such as a front panel for a projection television. Since the resin surface is easy to be scratched, a UV curable or thermosetting compound (such as an acrylate-based compound, an epoxy-type compound and an organic silicon compound) has been employed as a scratching-resistant coating in order to protect the surface (for example, Japanese Patent Application Laid-Open No. 9-48950). Further, in order to prevent adhesion of dust or the like, it is well known that a conductive inorganic particle is dispersed in a scratching-resistant coating to provide antistatic property (for example, Japanese Patent Publication Laid-Open Nos. 11-343430 and 2001-328220).

On the other hand, as a substrate for such a front panel for a display, a polymethyl methacrylate plate (a methacrylic resin plate) or the like bas been employed. The polymethyl methacrylate plate, however, is greatly expanded or contracted to possibly cause warp of the substrate due to the moisture absorption, which may result in strain of images of the display, contact of the substrate with parts in the inside of the front panel. As compared with the polymethyl methacrylate, it is known that methyl methacrylate-styrene copolymer-based resin has less moisture absorption (i.e., lower hygroscopicity), and therefore, it is proposed to use the methyl methacrylate-styrene copolymer-based resin for a front panel for a display (for example, Japanese Patent Application Laid-Open No. 11-7251).

However, a conventionally used acrylate-based curable compound has a different adhesion property depending on the type of resins to be used as a substrate, and especially in the case of using a methyl methacrylate-styrene copolymer-based resin plate as a substrate, the adhesion of the acrylate-based curable compound to the substrate is considerably decreased. On the other hand, from a curable compound which has a high adhesion to the methyl methacrylate-styrene copolymer-based resin plate, a cured coating with low hardness is made, the hardness being insufficient for a front panel of a display since the scratching resistant is needed.

### SUMMARY OF THE INVENTION

The inventors of the invention have made investigations in order to develop a scratching-resistant (and antistatic) resin plate, which has a cured coating with a sufficient adhesion to a low-hygroscopic methyl methacrylate-styrene copolymer-based resin plate and further with a sufficient surface hardness. As a result, the present inventors have found a resin composition (a coating material) which can provide a cured coating with a sufficient adhesion to a methyl methacrylate-styrene copolymer-based resin plate and with a sufficiently high surface hardness, and have completed the invention.

That is, the present invention provides a scratching-resistant resin plate comprising a substrate made from a methyl methacrylate-styrene copolymer-based resin and a cured coating formed on the substrate, wherein the cured coating comprises

(i) a resin composition containing

5 parts by weight to 80 parts by weight of a compound having an alicyclic ring and one or two (meth)acryloyloxy group(s) in its molecule and/or an oligomer of the compound, and

20 parts by weight to 95 parts by weight of a compound having at least three (meth)acryloyloxy groups in its molecule and/or an oligomer of the compound; and/or

(ii) a resin composition containing a compound having an aromatic ring and a (meth)acryloyloxy group so that the ratio of the number of (meth)acryloyloxy group to the number of aromatic ring is at least three.

In the present invention, in order to allow resin composition (ii) to contain a compound having an aromatic ring and a (meth)acryloyloxy group so that the ratio of the number of (meth)acryloyloxy group to the number of aromatic ring is at least three, for example, resin composition (ii) may be composed of a curable compound having an aromatic ring and at least three (meth)acryloyloxy groups per one aromatic ring in its molecule, or may be composed of a polyfunctional compound having at least three (meth)acryloyloxy groups in its molecule together with a compound having an aromatic ring and one or two (meth) acryloyloxy group(s) per one aromatic ring in its molecule. Further, a conductive inorganic particle with an average particle diameter of 0.1 μm or smaller may be dispersed in the above-mentioned cured coating to provide an antistatic property.

The scratching-resistant resin plate in the present invention is useful for a front panel for a display, especially, for a screen for a projection television. Accordingly, the present invention provides a front panel for a display and also provides a screen for a projection television, each panel being made of the above-mentioned scratching-resistant resin plate.

Further, the present invention provides a process for producing a scratching-resistant resin plate, the process comprising the steps of applying

(i) a resin composition containing

5 parts by weight to 80 parts by weight of a compound having an alicyclic ring and one or two (meth)acryloyloxy group(s) in its molecule and/or an oligomer of the compound, and

20 parts by weight to 95 parts by weight of a compound having at least three (meth)acryloyloxy groups in its molecule and/or an oligomer of the compound; and/or

(ii) a resin composition containing a compound having an aromatic ring and a (meth)acryloyloxy group so that the ratio of the number of (meth)acryloyloxy group to the number of aromatic ring is at least three,

onto a substrate made from a methyl methacrylate-styrene copolymer-based resin, to prepare a curable coating, and then curing the coating. When adding a conductive inorganic particle with an average particle diameter of 0.1 μm or smaller into resin composition(s) (i) and/or (ii) in the production process for the scratching-resistant resin plate, then the resulting scratching-resistant resin plate may have an antistatic property.

### DETAIL DESCRIPTION OF THE INVENTION

In the present invention, a methyl methacrylate-styrene copolymer-based resin, that is a resin comprising a copolymer of methyl methacrylate and styrene, is used as a substrate for a scratching-resistant resin plate. In the copolymer, the amount of styrene may be about 10% by weight to 90% by weight, is preferably not less than 20% by weight (further preferably not less than 30% by weight) and is preferably not more than 60%by weight (further preferably not more than 50% by weight). When the amount of styrene in the copolymer is less than 10% by weight, the moisture absorption of the methyl methacrylate-styrene copolymer-based resin may become high. When the amount of styrene in the copolymer exceeds 90% by weight, mechanical physical properties of the methyl methacrylate-styrene copolymer-based resin as a substrate is may deteriorate. The copolymer may contain an impact-resistant component. The methyl methacrylate-styrene copolymer-based resin may be cross-linked.

The substrate may have a smooth surface just like a sheet and a film or may have a surface with a curvature just like a convex lens and a concave lens. Alternatively, the surface may be a finely uneven surface. The appropriate thickness of the substrate may vary depending on the usage of the resulting scratching-resistant resin plate and may be selected in the range of 0.5 mm to 10 mm depending on the usage. In terms of the independency of the resulting scratching-resistant resin plate, the thickness of the substrate is preferably 1.5 mm or thicker.

A scratching-resistant resin plate in the invention has a cured coating on a substrate. The cured coating comprises

(i) a resin composition (a coating material) containing a compound having an alicyclic ring and one or two (meth)acryloyloxy group(s) in its molecule and/or an oligomer of the compound (hereinafter, the compound and the oligomer in all being sometimes referred to as an alicyclic (meth)acryloyloxy compound) as well as a resin composition (a coating material) containing a compound having at least three (meth)acryloyloxy groups in its molecule and/or an oligomer of the compound (hereinafter, the compound and the oligomer in all being sometimes referred to as a polyfunctional (meth)acryloyloxy compound); and/or

(ii) a resin composition (a coating material) containing a compound having an aromatic ring and a (meth)acryloyloxy group (hereinafter, the compound being sometimes referred to as an aromatic (meth)acryloyloxy compound) so that the ratio of the number of (meth)acryloyloxy group to the number of aromatic ring is at least three.

Incidentally, (meth)acryloyloxy group in the present invention includes acryloyloxy group and methacryloyoxy group and besides, “(meth)” in (meth)acrylate, (meth)acrylic acid and the like means the same.

In the present invention, the above-mentioned resin composition (i) may contain 5 parts by weight to 80 parts by weight of the alicyclic (meth)acryloyloxy compound and 20 parts by weight to 95 parts by weight of the polyfunctional (meth)acryloyloxy compound, based on 100 parts by weight of the total solid contents of the composition. Preferably, the alicyclic (meth)acryloyloxy compound is contained in a ratio of 10 parts by weight or more, and the polyfunctional (meth)acryloyloxy compound is contained in a ratio of 90 parts by weight or less. When the amount of the alicyclic (meth)acryloyloxy compound is too small, the adhesion of the resulting cured coating layer to a methyl methacrylate-styrene copolymer-based resin substrate may become insufficient. When the amount of the alicyclic (meth)acryloyloxy compound is too large, the surface hardness of the cured coating may be lowered. On the other hand, when the amount of the polyfunctional (meth)acryloyloxy compound is too small, the surface hardness of the cured coating may be lowered.

As mentioned above, the alicyclic (meth)acryloyloxy compound includes a compound having an alicyclic ring and one or two (meth)acryloyloxy group(s) in its molecule, and its oligomer. The alicyclic ring may be a carbon monocyclic ring such as a cyclohexane ring, may be a carbon polycyclic ring such as bicyclo[2.2.1]heptane ring (i.e., norbornane ring) and tricyclodecane ring or may be a heteroring such as tetrahydrofuran ring. Examples of the alicyclic (meth)acryloyloxy compound may include, for example, a dimethylol-tricyclodecane di(meth)acrylate, a tetrahydrofurfuryl (meth)acrylate, a 2-(meth)acryloyloxyethylhexahydrophthalic acid, an isobornyl (meth)acrylate, a pentaerythritol tri(meth)acrylate isophorone diisocyanate urethane prepolymer, and the like. Although the above exemplified compounds are all monomers, the alicyclic (meth)acryloyloxy compound may be used in the form of a monomer as they are, or may be used in the form of, for example, an oligomer such as a dimer and a trimer.

The alicyclic (meth)acryloyloxy compound may be a commercially available product. Examples of the commercially available alicyclic (meth)acryloyloxy compound include, for example, Newfrontier IBA (isobornyl acrylate, produced by Dai-ichi Kogyo Seiyaku Co., Ltd.), Aronix M-156 (isobornyl acrylate, produced by Toagosei Chemical Industry Co., Ltd.), Light Acrylate HOA-HH (2-acryloyloxyethylhexahydropthalic acid, produced by Kyoeisha Chemical Co., Ltd.), Light Acrylate DCP-A (dimethylol tricyclodecane diacrylate, produced by Kyoeisha Chemical Co., Ltd.), Light Acrylate THF-A (tetrahydrofurfuryl acrylate, produced by Kyoeisha Chemical Co., Ltd.), Light Acrylate UA-3061 (pentaerythritol triacrylate isophorone diisocyanate urethane prepolymer, produced by Kyoeisha Chemical Co., Ltd.), and the like.

As described above, the polyfunctional (meth)acryloyloxy compound is a compound having at least three (meth)acryloyloxy groups in its molecule, and its oligomer. The polyfunctional (meth)acryloyloxy compound needs to have at least three (meth)acryloyloxy groups in its molecule, and may have for example, four, five, six, seven, eight, or more (meth)acryloyloxy groups. Examples of the polyfunctional (meth)acryloyloxy compound may include, for example, a tri- or higher polyhydric alcohol poly(meth)acrylate such as a trimethylol propane tri(meth)acrylate, a trimethylol ethane tri(meth)acrylate, a glycerin tri(meth)acrylate, a pentaglycerol tri(meth)acrylate, a pentaerythritol tri- or tetra-(meth)acrylate, a dipentaerythritol tri-, tetra-, penta- or hexa-meth)acrylate, and a tripentaerythritol tetra-, penta-, hexa-, or hepta-(meth)acrylate; an urethane (meth)acrylate obtained by reacting a compound having at least two isocyanate groups in its molecule with a (meth)acrylate monomer having a hydroxyl group in an amount such that the molar amount of hydroxyl group is the same as or more than that of isocyanate group so as to have three or more (meth)acryloyloxy groups in its molecule; a tri(meth)acrylate of tris(2-hydroxyethyl)isocyanuric acid; and the like. Although the above exemplified compounds are all monomers, the polyfunctional (meth) acryloyloxy compound may be used in the form of a monomer as they are, or may be used in the form of, for example, an oligomer such as a dimer and a trimer.

The polyfunctional (meth)acryloyloxy compound may be a commercially available product. Examples of the commercially available polyfunctional (meth)acryloyloxy compound include, for example, NK Hard M101 (urethane-acrylate based, produced by Shin-Nakamura Chemical Co., Ltd.), NK Ester A-TMM-3L (pentaerythritol-acrylate, produced by Shin-Nakamura Chemical Co., Ltd.), NK Ester A-TMMT (pentaerythritol-tetraacrylate, produced by Shin-Nakamura Chemical Co., Ltd.), NK Ester A-9530 (dipentaerythritol-hexaacrylate, produced by Shin-Nakamura Chemical Co., Ltd.), KAYARAD DPCA (dipentaerythritol hexaacrylate, produced by Nippon Kayaku Co., Ltd.), and the like.

In the present invention, the above-mentioned resin composition (ii) is a resin composition containing an aromatic (meth)acryloyloxy compound so as to have at least three (meth)acryloyloxy groups per one aromatic ring. The aromatic ring may be a benzene ring, or may be a polycyclic ring such as naphthalene ring.

The resin composition (ii) may contain an aromatic (meth)acryloyloxy compound having at least three (meth)acryloyloxy groups per one aromatic ring, or may be a mixture of a polyfunctional compound having at least three (meth)acryloyloxy groups without any aromatic ring in its molecule (or a polyfunctional compound having at least three (meth)acryloyloxy groups with an aromatic ring and in its molecule) in combination with an aromatic (meth)acryloyloxy compound having one or two (meta)acryloyloxy groups per one aromatic ring so as to adjust the ratio in number of (meth)acryloyloxy groups to aromatic ring to be at least three as a whole in the mixture.

The polyfunctional compound having at least three (meth)acryloyloxy groups without any aromatic ring in its molecule may be the same type of compounds as the above-described polyfunctional (meth)acryloyloxy compounds. In resin composition (ii), the polyfunctional compound having at least three (meth) acryloyloxy groups without any aromatic ring in its molecule may have, for example, four, five, six, seven, eight, or more (meth)acryloyloxy groups.

The mixture using those compounds in combination can be prepared as follows:

Into an aromatic (meth)acryloyloxy compound having an aromatic ring and (meth)acryloyloxy group in a ratio of 1:1 in one molecule thereof, is added a polyfunctional compound having three (meth)acryloyloxy groups in one molecule thereof in an amount of ⅔ times or more by mole as much as that of the aromatic (meth)acryloyloxy compound or is added a polyfunctional compound having four (meth)acryloyloxy groups in one molecule thereof in an amount of ½ times or more by mole as much as that of the aromatic (meth) acryloyloxy compound; and into an aromatic (meth)acryloyloxy compound having an aromatic ring and (meth)acryloyloxy group in a ratio of 1:2 in one molecule thereof, is added a polyfunctional compound having three (meth)acryloyloxy groups in one molecule thereof in an amount of ⅓ times or more by mole as much as that of the aromatic (meth)acryloyloxy compound or is added a polyfunctional compound having four (meth)acryloyloxy groups in one molecule thereof in an amount of ¼ times or more by mole as much as that of the aromatic(meth)acryloyloxy compound. Alternatively, the above-mentioned resin composition (ii) in the form of mixture satisfying the condition that the ratio of the number of (meth)acryloyloxy group to the number of aromatic ring is at least three may be prepared by adding a prescribed amount of a compound having one or two (meth) acryloyloxy group(s) without any aromatic ring in one molecule thereof in prescribed amount or more to a curable compound having an aromatic ring and a (meth)acryloyloxy group in a ratio of 1:1 to 1:2 in one molecule thereof. Preferably, resin composition (ii) is prepared by adding a polyfunctional compound having at least three (meth)acryloyloxy groups in one molecule thereof.

In resin composition (ii), the compound having an aromatic ring allows the resulting cured coating to have improved adhesion to a methyl methacrylate-styrene copolymer-based resin substrate as compared with the compound having no an aromatic ring, and the adjustment of the ratio of (meth)acryloyloxy group to aromatic ring to be at least three allows the resulting cured coating to have improved surface hardness.

Examples of the aromatic (meth)acryloyloxy compound having at least three (meth)acryloyloxy groups per one aromatic ring may include, for example, a pentaerythritol triacrylate tolylenediisocyanate urethane prepolymer, a glycerin dimethacrylate tolylenediisocyanate urethane prepolymer, and the like. Pentaerythritol triacrylate tolylenediisocyanate urethane prepolymer is a compound having one aromatic ring and six acryloyloxy groups in one molecule thereof. Glycerin dimethacrylate tolylenediisocyanate urethane prepolymer is a compound having one aromatic ring and four methacryloyoxy groups in one molecule thereof. These urethane prepolymers may be used respectively in the form of monomer as they are, or may be used in the form of mixture containing their dimers, their trimers and the like, or may be used substantially in the form of oligomers.

The (meth)acryloyloxy compound having at least three (meth)acryloyloxy groups per one aromatic ring may be a commercially available product. Examples of such a commercially available (meth) acryloyloxy compound may include, for example, Light Acrylate UA-306T (pentaerythritol triacrylate tolylenediisocyanate urethane prepolymer, produced by Kyoeisha Chemical Co., Ltd.), Light Acrylate UA-101T (glycerin dimethacrylate tolylenediisocyanate urethane prepolymer, produced by Kyoeisha Chemical Co., Ltd.), and the like.

Examples of the aromatic (meth)acryloyloxy compound having two or less of (meth)acryloyloxy groups per one aromatic ring may include a phenoxyethyl methacrylate, a phenol ethylene oxide-modified acrylate, a cresol ethylene oxide-modified acrylate, a p-cumylphenol ethylene oxide-modified acrylate, a nonylphenol ethylene oxide-modified acrylate, a nonylphenol propylene oxide-modified acrylate, a phenyl glycidyl ether acrylate hexamethylene diisocyanate urethane prepolymer, a phenyl glycidyl ether acrylate tolylene diisocyanate urethane prepolymer, a bisphenol A ethylene oxide-modified di(meth)acrylate such as a 2,2-bis[4-(meth)acryloyloxyethoxyphenyl]propane and a 2, 2-bis[4-(meth)acryloyloxyethoxyethoxyphenyl]propane, a bis phenol F ethylene oxide-modified di(meth)acrylate such as a bis[4-(meth)acryloyloxyethoxyphenyl]methane and a bis[4-(meth)acryloyloxyethoxyethoxyphenyl]methane, and the like. Although the above exemplified compounds are all monomers, the (meth)acryloyloxy compound (having two or less of (meth)acryloyloxy groups per one aromatic ring) may be used in the form of monomer as they are, or may be used in the form of, for example, an oligomer such as a dimer and a trimer.

The (meth)acryloyloxy compound having two or less of (meth)acryloyloxy groups per one aromatic ring may be a commercially available product. Examples of such a commercially available (meth) acryloyloxy compound include, for example, Light Acrylate AH-600 (phenyl glycidyl ether acrylate hexamethylene diisocyanate urethane prepolymer, produced by Kyoeisha Chemical Co., Ltd.), Light Acrylate AT-600 (phenyl glycidyl ether acrylate tolylenediisocyanate urethane prepolymer, produced by Kyoeisha Chemical Co., Ltd.), Light Acrylate BP-4EA (2,2-bis(4-acryloyloxyethoxyethoxylphenyl)propane, produced by Kyoeisha Chemical Co., Ltd.), NK Ester A-BPE-4 (2,2-bis(4-acryloyloxyethoxyethoxyphenyl)propane, produced by Shin-Nakamura Chemical Co., Ltd.), Aronix M-208 (bisphenol F ethylene oxide-modified diacrylate, produced by Toagosei Chemical Industry Co., Ltd.), and the like.

In the case of using resin composition (ii) in the present invention, when an aromatic (meth)acryloyloxy compound having two or less of (meth)acryloyloxy groups per one aromatic ring is employed, it is required to use the above-described polyfunctional (meth)acryloyloxy compound in combination. On the other hand, when an aromatic (meth)acryloyloxy compound having at least three (meth)acryloyloxy groups per one aromatic ring is employed, such a polyfunctional (meth)acryloyloxy compound may or may not be used.

The alicyclic (meth)acryloyloxy compound, the aromatic (meth)acryloyloxy compound and the polyfunctional (meth)acryloyloxy compound to be used in the invention can be cured by irradiation of energy beam such as electron beam, radiation beam and ultraviolet ray or by heating.

Resin composition (i) and resin composition (ii) may contain a conductive inorganic particle with an average particle diameter of 0.1 μm or smaller, to attain electric conductivity (i.e., antistatic property). Examples of the conductive inorganic particle may include, for example, an antimony-doped tin oxide, a phosphorus-doped tin oxide, an antimony oxide, a zinc antimonate, a titanium oxide, a tin-doped indium oxide (ITO: indium tin oxide) and the like.

In the case of using the conductive inorganic particle, the average particle diameter of the particle may be 0.1 μm or smaller and may be 0.001 μm or larger. When the average particle diameter of the conductive inorganic particle exceeds 0.1 μm, the haze of the resulting scratching-resistant resin plate tends to become large and the transparency thereof tends to be lowered. Further, in the case of using the conductive inorganic particle, its amount may be about 2 parts by weight to 25 parts by weight, is preferably 15 parts by weight or less, and is more preferably 10 parts by weight or less, based on 100 parts by weight of the total amount of the compounds having (meth)acryloyloxy groups (that is, the total amount of the alicyclic (meth)acryloyloxy compound, the aromatic (meth)acryloyloxy compound and the polyfunctional (meth)acryloyloxy compound). When the amount of the conductive inorganic particle is less than 2 parts by weight based on 100 parts by weight of the total amount of the compounds having (meth)acryloyloxy groups, the conductivity of the resulting cured coating may becomes insufficient. On the other hand, when the amount exceeds 25 parts by weight, the total luminous transmittance tends to be decreased, and the haze tends to be increased.

Such a conductive inorganic particle may be produced by, for example, a vapor phase decomposition method, a plasma deposition method, an alkoxide decomposition method, a coprecipitation method, a hydrothermal method and the like. The surface of the conductive inorganic particle may be subjected to a surface treatment with, for example, a nonionic surfactant, a cationic surfactant, an anionic surfactant, a silicon-type coupling agent, an aluminum-type coupling agent and the like.

Resin compositions (i) and (ii) can be prepared by mixing an alicyclic (meth)acryloyloxy compound, an aromatic (meth)acryloyloxy compound, a polyfunctional (meth)acryloyloxy compound and an optional conductive inorganic particle in respective prescribed amounts. In the preparing of resin compositions (i) and (ii), it is preferred to use a solvent together. When a conductive inorganic particle and a solvent are used in combination, the preparing may be conducted by mixing a conductive inorganic particle with a solvent to disperse the conductive inorganic particle in the solvent and then adding a (meth)acryloyloxy compound appropriately selected from alicyclic (meth)acryloyloxy compounds, aromatic (meth)acryloyloxy compounds and polyfunctional (meth)acryloyloxy compounds thereto. Alternatively, the preparing may be conducted by mixing such a (meth)acryloyloxy compound with a solvent and then adding a conductive inorganic particle thereto.

The solvent which may be used in resin compositions (i) and (ii) is preferably a solvent which can dissolve an alicyclic (meth)acryloyloxy compound, an aromatic (meth)acryloyloxy compound and a polyfunctional (meth)acryloyloxy compound therein and can be evaporated after being applied on to a substrate. Also, when a conductive inorganic particle is used as a component of the resin compositions (coating materials), the solvent is preferably a solvent which can dissolve the particle therein. Examples of such a solvent include an alcohol such as a diacetone alcohol, a methanol, an ethanol, an isopropyl alcohol and a 1-methoxy-2-propanol; a ketone such as an acetone, a methyl ethyl ketone and a methyl isobutyl ketone; an aromatic hydrocarbon such as a toluene and a xylene; an ester such as an ethyl acetate; water; and the like. Two or more kinds of solvents may be used if necessary.

Resin compositions (i) and (ii) may contain other monomer components as well as the above-described conductive inorganic particle, if necessary.

Besides the added based on the necessity, the.

Examples of other monomer components which may be added in resin compositions (i) and (ii) include a mixed polyester of a saturated or unsaturated dibasic acid with a (meth)acrylic acid. Specifically, examples include mixed polyesters in combinations of compounds as follows (hereinafter, A/B/C meaning a mixture of A, B and C): malonic acid/trimethylol ethane/(meth)acrylic acid, malonic acid/trimethylol propane/(meth)acrylic acid, malonic acid/glycerin/(meth)acrylic acid, malonic acid/pentaerythritol/(meth)acrylic acid, succinic acid/trimethylol ethane/(meth)acrylic acid, succinic acid/trimethylol propane/(meth)acrylic acid, succinic acid/glycerin/(meth)acrylic acid, succinic acid/pentaerythritol/(meth)acrylic acid, glutaric acid/trimethylol ethane/(meth)acrylic acid, glutaric acid/trimethylol propane/(meth)acrylic acid, glutaric acid/glycerin/(meth)acrylic acid, glutaric acid/pentaerythritol/(meth)acrylic acid, adipic acid/trimethylol ethane/(meth)acrylic acid, adipic acid/trimethylol propane/(meth)acrylic acid, adipic acid/glycerin/(meth)acrylic acid, adipic acid/pentaerythritol/(meth)acrylic acid, sebacic acid/trimethylol methane/(meth)acrylic acid, sebacic acid/trimethylol ethane/(meth)acrylic acid, sebacic acid/trimethylol propane/(meth)acrylic acid, sebacic acid/glycerin/(meth)acrylic acid, sebacic acid/pentaerythritol/(meth)acrylic acid, fumaric acid/trimethylol ethane/(meth)acrylic acid, fumaric acid/trimethylol propene/(meth)acrylic acid, fumaric acid/glycerin/(meth)acrylic acid, fumaric acid/pentaerythritol/(meth)acrylic acid, itaconic acid/trimethylol ethane/(meth)acrylic acid, itaconic acid/trimethylol propene/(meth)acrylic acid, itaconic acid/pentaerythritol/(meth)acrylic acid, maleic anhydride/trimethylol ethane/(meth)acrylic acid, maleic anhydride/glycerin/(meth)acrylic acid and the like.

When such other monomer components are used, the amount thereof to be used may be about 30% by weight or less based on the total solid contents of the composition. The mixing order of such other monomer components, an alicyclic, aromatic and/or polyfunctional (meth)acryloyloxy compound(s), an inorganic conductive particle and a solvent is not limited. For example, other monomer components may be dissolved together with the alicyclic, aromatic and/or polyfunctional (meth)acryloyloxy compound(s) in a solvent. When a conductive inorganic particle is used, such other monomer components may be mixed in a solvent together with the particle, or may be mixed before or after mixing a (meth)acryloyloxy compound with a solvent.

In order to be cured on a substrate, resin compositions (i) and (ii) may contain a polymerization initiator. The polymerization initiator may be an initiator which is commonly used for curing acrylic curable compounds. Further, resin compositions (i) and (ii) may contain a leveling agent and other various additives if necessary.

In the present invention, the resin composition (coating material) obtained in such a manner as described above is applied onto the surface of a methyl methacrylate-styrene copolymer-based resin substrate and is cured to obtain a scratching-resistant resin plate. To apply the above-mentioned resin composition (coating material) to the substrate, for example, a commonly used method such as a bar coater method, a roll coater method and the like can be employed. In such a manner, a curable coating can be placed on the surface of a substrate. After that, the curable coating on the substrate surface is cured to be a cured coating by radiating energy beam or heating, which providing a scratching-resistant resin plate. The cured coating is made of cured compound of a (meth) acryloyloxy compound selected from an alicyclic (meth) acryloyloxy compound, an aromatic (meth)acryloyloxy compound and a polyfunctional (meth)acryloyloxy compound, with an optional conductive inorganic particle dispersed therein.

When the resin composition is cured by radiating energy beam, the energy beam to be employed may be, for example, ultraviolet rays, electron beam, radiation beam and the like, and the intensity and radiation time thereof can be properly adjusted depending on the kinds and components of the alicyclic (meth)acryloyloxy compounds, aromatic (meth)acryloyloxy compounds and polyfunctional (meth)acryloyloxy compounds to be used. When the resin composition is cured by heating, the heating temperature and heating time can also be adjusted properly depending on the kinds and components of the alicyclic (meth)acryloyloxy compounds, aromatic (meth)acryloyloxy compounds and polyfunctional (meth)acryloyloxy compounds. When the resin composition (coating material) containing a solvent is applied onto a substrate, the coating applied on the substrate may be cured after the solvent is evaporated, or the solvent evaporation and the curing of the coating may be carried out simultaneously.

The thickness of the cured coating formed in such a manner is preferably about 0.5 μm to 50 μm, and is more preferably about 1 μm or thicker and about 20 μm or thinner. When the thickness of the cured coating exceeds 50 μm, cracking may easily take place. When the thickness is thinner than 0.5 μm, the scratching resistance of the resulting resin plate tends to become insufficient. Onto the cured coating, a variety of functional layers such as a low-reflection layer, a stain-proof layer and the like may be further superimposed.

The scratching-resistant resin plate in the present invention has a low moisture absorption, so that the warping of the plate can be small even when the plate is used for a long period of time. In addition, the surface hardness of the cured coating in the plate is sufficient. Therefore, the plate is useful for a front panel for a display, the panel allowing a light from the display screen to transmit. Examples of the display include a cathode-ray tube (CRT), a liquid crystal display apparatus (LCD), a plasma display panel (PDP), an electroluminescence display (ELD), a light emitting diode display and the like.

Also, the scratching-resistant resin plate in the present invention can be used as a front panel for a projection-type display (such as a projection television) for projecting images on the surface of the front panel. In this case, as compared with a case of using a methacrylic resin plate, the projected images may have high quality without distortion, since the amount of the moisture absorption from the surface of the resin plate in the present invention is small and the warping of the plate is small. Therefore, the scratching-resistant resin plate of the present invention is useful for a screen for a projection-type display.

Especially, it is easy for a large size (for example, with 40 inch or longer diagonal length) of front panel for a display or of screen for projection-type display to be expanded or contracted due to the moisture absorption to cause problems such as warping. Therefore, when being used for such a purpose, it is desired that a scratching-resistant resin plate absorbs little water even if being exposed to hot water. Preferably, when being immersed in hat water at 60° C. for 24 hours, the moisture absorption of the plate is about 1% or less. The moisture absorption can be calculated by dividing the increase in weight of the resin plate when being immersed in the water by the weight of the resin plate before the immersion.

According to the present invention, by specifying the combination of a substrate resin and a cured coating formed thereon, a scratching-resistant resin plate with a low moisture absorption, on which the cured coating with a high adhesion to the substrate and a high surface hardness is properly provided, can be obtained. In the production process of the scratching-resistant resin plate, by dispersing a conductive inorganic particle in the resin composition for preparing the cured coating so as to disperse the conductive inorganic particle in the resulting cured coating, the scratching-resistant resin plate is further provided with an antistatic property as well. The resin plate is useful especially for a variety of front panels for displays, a screen for a projection television and the like.

The invention being thus described, it will be apparent that the same may be varied in many ways. Such variations are to be regarded as within the spirit and scope of the invention, and all such modifications as would be apparent to one skilled in the art are intended to be within the scope of the following claims.

### EXAMPLES

The present invention is described in more detail by reference to the following Examples, which should not be construed as a limitation upon the scope of the present invention. In Examples, % and part(s) describing concentrations or amounts are on the basis of weight unless otherwise mentioned.

Resin plates were evaluated by the methods as follows.

(1) Total Light Transmittance Tt

In accordance with ASTM D-1003, transmitted light amount in relation to incident light amount of visible light was measured to obtain total light transmittance Tt.

(2) Haze

Haze was measured in accordance with ASTM D-1003.

(3) Steel Wool Hardness

The generation of scratches on cured coatings was observed with eyes after 10-time reciprocation of steel wool No. 0000 with a load of 500 g/cm².

(4) Adhesion Property of Cured Coatings

After sample plate to be measured was immersed in hot water at 80° C. for 1 hour and was cooled to a normal temperature, occurrence of peeling in 100 checkers formed in a cured coating of the plate was observed by a cross cut tape test method in accordance with JIS K 5400.

### Example 1A

A coating material was prepared by mixing 12.5 parts by weight of dipentaerythritol hexaacrylate (NK Ester A-9530, obtained from Shin-Nakamura Chemical Co., Ltd.), 12.5 parts by weight of dimethylol tricyclodecane diacrylate (Light Acrylate DCP-A, obtained from Kyoeisha Chemical Co., Ltd.) and 75 parts by weight of 1-methoxy-2-propanol and adding 1.25 parts by weight of 1-hydroxycyclohexyl phenyl ketone (Irgacure 184, polymerization initiator, obtained from Ciba Specialty Chemicals Co., Ltd.) thereto. The obtained coating material was applied onto one surface of a methyl methacrylate-styrene copolymer-based resin plate (produced from a copolymer of methyl methacrylate and styrene in a ratio of 60/40 by weight to be a 3 mm-thick plate by an extruder) by a bar coater and was dried to place a curable coating. By irradiation of ultraviolet ray, the coating was cured to obtain a resin plate with a cured coating. The thickness of the cured coating was about 4 μm. The evaluation results of the resin plate are shown in Table 1.

### Examples 2A and 3A

Resin plates each having a cured coating with a thickness of about 4 μm were obtained in the same manner as in Example 1A, except that the following compounds were used in place of dipentaerythritol hexaacrylate (NK Ester A-9530). Those two types of compounds employed here were produced by different companies and, therefore, tests were carried out for the respective compounds. The evaluation results of the obtained resin plates are shown in Table 1.

Example 2A: Pentaerythritol tetraacrylate (NK Ester A-TMMT, obtained from Shin-Nakamura Chemical Co., Ltd.),

Example 3A: Pentaerythritol tetraacrylate (KAYARAD PET 30, obtained from Nippon Kayaku Co., Ltd.).

### Example 4A

A coating material was prepared by mixing 15.6 parts by weight (12.5 parts by weight in terms of solid contents) of urethane acrylate-based curable compound (NK Hard M101; a mixture of compounds having 3 to 6 acryloyloxy groups in one molecule thereof; 80% by weight in terms of solid contents; obtained from Shin-Nakamura Chemical Co., Ltd.) and 12.5 parts by weight of dimethylol tricyclodecane diacrylate (Light Acrylate DCP-A, obtained from Kyoeisha Chemical Co., Ltd.) and adding 71.9 parts by weight of 1-methoxy-2-propanol thereto to obtain 100 parts by weight of a mixture, and further mixing the mixture with 1.25 parts by weight of 1-hydroxycyclohexyl phenyl ketone (Irgacure 184, polymerization initiator, obtained from Ciba Specialty Chemicals Co., Ltd.). A resin plate having a cured coating with a thickness of about 4 μm was obtained in the same manner as in Example 1A, except that the obtained coating material was used. The evaluation results of the obtained resin plate are shown in Table 1.

### Example 5A

A scratching-resistant coating material was prepared by mixing 12.5 parts by weight of dipentaerythritol hexaacrylate (NK Ester A-9530, obtained from Shin-Nakamura Chemical Co., Ltd.), 12.5 parts by weight of dimethylol tricyclodecane diacrylate (Light Acrylate DCP-A, obtained from Kyoeisha Chemical Co., Ltd.) and 75 parts by weight of 1-methoxy-2-propanol and adding 1.25 parts by weight of 1-hydroxycyclohexyl phenyl ketone (Irgacure 184, polymerization initiator, obtained from Ciba Specialty Chemicals Co., Ltd.) thereto, and further adding adding 10 parts by weight of a diantimony pentoxide dispersion (ELCOM PC-14, 20% by weight concentration, 20 nm to 30 nm average particle diameter of dispersed diantimony pentoxide, obtained from Catalysts and Chemicals Industries Co., Ltd.). A resin plate having a cured coating with a thickness of about 4 μm was obtained in the same manner as in Example 1A, except that the obtained scratching-resistant coating material was used. The evaluation results of the obtained resin plate are shown in Table 1. Further, with respect to the obtained resin plate with the cured coating, the surface resistance of the cured coating was measured in accordance with JIS K 6911. As a result, the surface resistance was 5.9×10¹⁰ Ω/□.

### Comparative Example 1A

A coating material was prepared by adding 1.25 parts by weight of 1-hydroxycyclohexyl phenyl ketone (Irgacure 184, polymerization initiator, obtained from Ciba Specialty Chemicals Co., Ltd.) to 31.3 parts by weight (25 parts by weight in terms of solid contents) of urethane acrylate-based curable compound (NK Hard M101; a mixture of compounds having 3 to 6 acryloyloxy groups in one molecule thereof; 80 t by weight in terms of solid contents; obtained from Shin-Nakamura Chemical Co., Ltd.) and 68.7 parts by weight of 1-methoxy-2-propanol. A resin plate having a cured coating with a thickness of about 4 μm was obtained in the same manner as in Example 1A, except that the obtained coating material was used. The evaluation results of the obtained resin plate are shown in Table 1.

### Comparative Example 2A

A resin plate having a cured coating with a thickness of about 4 μm was obtained in the same manner as in Example 1A, except that the amount of dimethylol tricyclodecane diacrylate (Light Acrylate DCP-A) was changed to 25 parts by weight, and dipentaerythritol hexaacrylate (NK Ester A-9530) was not used. The evaluation results of the obtained resin plate are shown in Table 1.

TABLE 1

| | Total light | | | Adhesion after |
|---|---|---|---|---|
| | transmittance | | Steel wool | immersion in hot |
| | Tt | Haze | hardness | water |
| Example 1A | 91.6% | 0.5% | Good | No peeling observed |
| Example 2A | 91.2% | 0.1% | Good | No peeling observed |
| Example 3A | 91.7% | 0.8% | Good | No peeling observed |
| Example 4A | 91.0% | 1.1% | Good | No peeling observed |
| Example 5A | 91.4% | 0.4% | Good | No peeling observed |
| Comparative | 92.1% | 0.2% | Good | Peeling observed |
| Example 1A | | | | |
| Comparative | 91.9% | 1.2% | Many | No peeling observed |
| Example 2A | | | scratches | |

### Example 6A

A resin plate having a cured coating was produced in the same manner as in Example 1A, except that the thickness of the methyl methacrylate-styrene copolymer-based resin plate was changed to be 2 mm. The resin plate was vacuum dried at 80° C. for 4 hours, and the weight of the resin plate before immersion was measured. The plate was immersed in water at 23° C. for 24 hours, and the weight of the plate after the immersion was measured. The water absorption of the resin plate was calculated using the following equation, to evaluate the moisture absorption of the plate:

Moisture absorption={(weight after immersion−weight before immersion}/weight before immersion)×100%.

As a result, the moisture absorption of the plate in the case of immersion in water at 23° C. for 24 hours was 0.39%. In the same manner, a resin plate having a cured coating was produced and was evaluated by being immersed in hot water at 60° C. for 24 hours. As a result, the moisture absorption of the plate in the case of immersion in hot water at 60° C. for 24 hours was 0.83%.

### Comparative Example 3A

A resin plate having a cured coating was produced in the same manner as in Example 1A, except that a 2 mm-thick methacrylic resin plate (Sumipeck E, obtained from Sumitomo Chemical Co., Ltd.) was used in place of the 3 mm-thick methyl methacrylate-styrene copolymer-based resin plate. With respect to the resin plate, the moisture absorption was evaluated in the same manner as in Example 6A. As a result, the moisture absorption of the plate in the case of immersion in water at 23° C. for 24 hours was 0.44%, and the moisture absorption of the plate in the case of immersion in hot water at 60° C. for 24 hours was 1.30%.

### Example 1B

A coating material was prepared by adding 1.25 parts by weight of 1-hydroxycyclohexyl phenyl ketone (Irgacure 184, polymerization initiator, obtained from Ciba Specialty Chemicals Co., Ltd.) to 25 parts of pentaerythritol triacrylate tolylene diisocyanate urethane prepolymer (Light Acrylate UA-306T, produced by Kyoeisha Chemical Co., Ltd.) and 75 parts of 1-methoxy-2-propanol. The coating material was applied onto one surface of a methyl methacrylate-styrene copolymer-based resin plate (produced from a copolymer of methyl methacrylate and styrene in a ratio of 60/40 by weight to be a 3 mm-thick plate by an extruder) by a bar coater and was dried to place a curable coating. By irradiation of ultraviolet ray, the coating was cured to obtain a resin plate with a cured coating. The thickness of the cured coating was about 4 μm. The evaluation results of the resin plate are shown in Table 2.

### Example 2B

A coating material was prepared by adding 12.5 parts of 1-hydroxycyclohexyl phenyl ketone (Irgacure 184, polymerization initiator, obtained from Ciba Specialty Chemicals Co., Ltd.) to 7.5 parts of dipentaerythritol hexaacrylate (NK Ester A-9530, obtained from Shin-Nakamura Chemical Co., Ltd.), 17.5 parts of pentaerythritol triacrylate tolylene diisocyanate urethane prepolymer (Light Acrylate UA-306T, obtained from Kyoeisha Chemical Co., Ltd.) and 75 parts of 1-methoxy-2-propanol. A resin plate having a cured coating with a thickness of about 4 μm was produced by the same manner as in Example 1B using the obtained coating material. The evaluation results of the obtained resin plate are shown in Table 2.

### Example 3B

A resin plate having a cured coating with a thickness of about 4 μm was obtained in the same manner as in Example 2B, except that pentaerythritol tetraacrylate (KAYARAD PET 30, obtained from Nippon Kayaku Co., Ltd.) was used in place of dipentaerythritol hexaacrylate (NK Ester A-9530). The evaluation results of the obtained resin plate are shown in Table 2.

### Example 4B

A coating material was prepared by mixing 9.4 parts (7.5 parts in terms of solid contents) of urethane acrylate-based curable compound (NK Hard M101; a mixture of compounds having 3 to 6 acryloyloxy groups in one molecule thereof; 80% by weight in terms of solid contents; obtained from Shin-Nakamura Chemical Co., Ltd.), 17.5 parts of pentaerythritol triacrylate tolylene diisocyanate urethane prepolymer (Light Acrylate UA-306T, obtained from Kyoeisha Chemical Co., Ltd.) and 73.1 parts of 1-methoxy-2-propanol, and further adding 1.25 parts of 1-hydroxycyclohexyl phenyl ketone (Irgacure 184, polymerization initiator, obtained from Ciba Specialty Chemicals Co., Ltd.) thereto. A resin plate having a cured coating with a thickness of about 4 μm was obtained in the same manner as in Example 1B using the obtained coating material. The evaluation results of the obtained resin plate are shown in Table 2.

### Example 5B

A scratching-resistant coating material was prepared by adding 1.25 parts by weight of 1-hydroxycyclohexyl phenyl ketone (Irgacure 184, polymerization initiator, obtained from Ciba Specialty Chemicals Co., Ltd.) to 25 parts of pentaerythritol triacrylate tolylene diisocyanate urethane prepolymer (Light Acrylate UA-306T, obtained from Kyoeisha Chemical Co., Ltd.) and 75 parts of 1-methoxy-2-propanol, and further adding 20 parts of diantimony pentoxide dispersion (ELCOM PC-14, 20% by weight concentration, 20 nm to 30 nm average particle diameter of dispersed diantimony pentoxide, obtained from Catalysts and Chemicals Industries Co., Ltd.) thereto. A resin plate having a cured coating with a thickness of about 4 μm was obtained in the same manner as Example 1B using the scratching-resistant coating material. The evaluation results of the obtained resin plate are shown in Table 2. Further, with respect to the obtained resin plate with the cured coating, the surface resistance of the cured coating was measured in accordance with JIS K 6911. As a result, the surface resistance was 1×10¹² Ω/□.

### Example 6B

A coating material was prepared by adding 12.5 parts of 1-hydroxycyclohexyl phenyl ketone (Irgacure 184, polymerization initiator, obtained from Ciba Specialty Chemicals Co., Ltd.) to 20 parts of dipentaerythritol hexaacrylate (NK Ester A-9530, obtained from Shin-Nakamura Chemical Co., Ltd.), 5 parts of 2,2-bis(4-acryloyloxyethoxyethoxyphenyl)propane (Light Acrylate BP-4EA, obtained from Kyoeisha Chemical Co., Ltd.), 25 parts of 1-methoxy-2-propanol and 50 parts of 2-methyl-1-propanol. A resin plate having a cured coating with a thickness of about 4 μm was produced in the same manner as in Example 1B using the obtained coating material. The evaluation results of the obtained resin plate are shown in Table 2.

### Example 7B

A resin plate having a cured coating with a thickness of about 4 μm was produced in the same manner as in Example 6B, except that bisphenol F ethylene oxide-modified diacrylate (Aronix M-208, produced by Toagosei Chemical Industry Co., Ltd.) was used in place of 2,2-bis(4-acryloyloxyethoxyethoxyphenyl)propane (Light Acrylate BP-4EA). The evaluation results of the obtained resin plate are shown in Table 2.

### Comparative Example 1B

A coating material was prepared by adding 1.25 parts of 1-hydroxycyclohexyl phenyl ketone (Irgacure 184, polymerization initiator, obtained from Ciba Specialty Chemicals Co., Ltd.) to 31.3 parts (25 parts in terms of solid contents) of urethane acrylate-based curable compound (NK Hard M101; a mixture of compounds having 3 to 6 acryloyloxy groups in one molecule thereof; 80% in terms of solid contents; obtained from Shin-Nakamura Chemical Co., Ltd.) and 68.7 parts of 1-methoxy-2-propanol. A resin plate having a cured coating with a thickness of about 4 μm was obtained in the same manner as in Example 1B using the obtained coating material. The evaluation results of the obtained resin plate are shown in Table 2.

### Comparative Example 2B

A coating material was prepared in the same manner as in Example 1B, except that 25 parts of 2-acryloyloxyethyl 2-hydroxyethyl phthalate (Light Acrylate HOA-MPE, obtained from Kyoeisha Chemical Co., Ltd.) was used in place of 25 parts of pentaerythritol triacrylate tolylene diisocyanate urethane prepolymer (Light Acrylate UA-306T). A resin plate having a cured coating with a thickness of about 4 μm was obtained in the same manner as in Example 1B using the obtained coating material. The evaluation results of the obtained resin plate are shown in Table 2.

TABLE 2

| | Total light | | | Adhesion after |
|---|---|---|---|---|
| | transmittance | | Steel wool | immersion in hot |
| | Tt | Haze | hardness | water |
| Example 1B | 91.3 | 0.4 | Good | No peeling observed |
| Example 2B | 90.5 | 0.6 | Good | No peeling observed |
| Example 3B | 91.1 | 0.1 | Good | No peeling observed |
| Example 4B | 90.1 | 0.1 | Good | No peeling observed |
| Example 5B | 91.3 | 0.4 | Good | No peeling observed |
| Example 6B | 91.0 | 0.2 | Good | No peeling observed |
| Example 7B | 91.6 | 0.2 | Good | No peeling observed |
| Comparative | 91.2 | 0.5 | Good | Peeling observed |
| Example 1B | | | | |
| Comparative | 91.1 | 0.7 | Many | No peeling observed |
| Example 2B | | | scratches | |

### Example 8B

A resin plate having a cured coating was produced in the same manner as in Example 1B, except that the thickness of the methyl methacrylate-styrene copolymer-based resin plate was changed to be 2 mm. With respect to the resin plate, the moisture absorption was evaluated by the same method as that in Example 6A. As a result, the moisture absorption of the plate in the case of immersion in water at 23° C. for 24 hours was 0.45%, and the moisture absorption of the plate in the case of immersion in hot water at 60° C. for 24 hours was 0.9%.

### Comparative Example 3B

A resin plate baving a cured coating was produced in the same manner as in Example 1B, except that a 2 mm-thick methacrylic resin plate (Sumipeck E, obtained from Sumitomo Chemical Co., Ltd.) was used in place of a 3 mm-thick methyl methacrylate-styrene copolymer-based resin plate. With respect to the resin plate, the moisture absorption was evaluated in the same manner as in Example 6A. As a result, the moisture absorption of the plate in the case of immersion in water at 23° C. for 24 hours was 0.52%, and the moisture absorption of the plate in the case of immersion in hot water at 60° C. for 24 hours was 1.35%.

What is claimed is:

1. A scratching-resistant resin plate comprising a substrate made from a methyl methacrylate-styrene copolymer-based resin and a cured coating formed on the substrate, wherein the cured coating comprises
(i) a resin composition containing
5 parts by weight to 80 parts by weight of a compound having an alicyclic ring and one or two (meth)acryloyloxy group(s) in its molecule and/or an oligomer of the compound, and
20 parts by weight to 95 parts by weight of a compound having at least three (meth)acryloyloxy groups in its molecule and/or an oligomer of the compound; and/or
(ii) a resin composition containing a compound having an aromatic ring and a (meth)acryloyloxy group so that the ratio of the number of (meth)acryloyloxy group to the number of aromatic ring is at least three.

2. A resin plate according to claim 1., wherein the cured coating comprises resin composition (i) containing
5 parts by weight to 80 parts by weight of a compound having an alicyclic ring and one or two (meth)acryloyloxy group(s) in its molecule and/or an oligomer of the compound, and
20 parts by weight to 95 parts by weight of a compound having at least three (meth)acryloyloxy groups in its molecule and/or an oligomer of the compound.

3. A resin plate according to claim 1, wherein the cured coating comprises resin composition (ii) containing a compound having an aromatic ring and a (meth)acryloyloxy group so that the ratio of the number of (meth) acryloyloxy group to the number of aromatic ring is at least three.

4. A resin plate according to claim 3, wherein resin composition (ii) contains a compound having an aromatic ring and at least three (meth)acryloyloxy groups per one aromatic ring in its molecule.

5. A resin plate according to claim 3, wherein resin composition (ii) contains a polyfunctional compound having having at least three (meth)acryloyloxy groups in its molecule.

6. A resin plate according to any one of claims 1, 4 and 5, wherein the cured coating has a conductive inorganic particle with an average particle diameter of 0.1 μm or smaller.

7. A resin plate according to any one of claims 1, 4 and 5, wherein the resin plate has a moisture absorption of about 1% or less, when being immersed in hat water at 60° C. for 24 hours.

8. A front panel for a display, the panel being made of the resin plate claimed in any one of claims 1, 4 and 5.

9. A screen for a projection-type display, the screen being made of the resin plate claimed in any one of claims 1, 4 and 5.

10. A process for producing a scratching-resistant resin plate, the process comprising the steps of applying
(i) a resin composition containing
5 parts by weight to 80 parts by weight of a compound having an alicyclic ring and one or two (meth)acryloyloxy group(s) in its molecule and/or an oligomer of the compound, and
20 parts by weight to 95 parts by weight of a compound having at least three (meth)acryloyloxy groups in its molecule and/or an oligomer of the compound; and/or
(ii) a resin composition containing a compound having an aromatic ring and a (meth)acryloyloxy group so that the ratio of the number of (meth)acryloyloxy group to the number of aromatic ring is at least three,
onto a substrate made from a methyl methacrylate-styrene copolymer-based resin, to place a curable coating on the substrate; and then curing the coating.

11. A process according to claim 10, wherein the resin composition used therein has a conductive inorganic particle with an average particle diameter of 0.1 μm or smaller.
